(19) United States
(12) Patent Application Publication
(10) Pub. No.: US 2006/0079973 A1
(43) Pub. Date: Apr. 13, 2006

(54) Handheld roster device and method

(76) Inventor: Mel L. Bacharach, San Francisco, CA (US)

Correspondence Address: NIXON PEABODY, LLP, 401 9TH STREET, NW, SUITE 900, WASHINGTON, DC, 20004-2128, US

(21) Appl. No.: 11/244,367

(22) Filed: Oct. 5, 2005

Related U.S. Application Data
(60) Provisional application No. 60/616,990, filed on Oct. 7, 2004.

(51) Int. Cl. G06F 19/00

(52) U.S. Cl. 700/91

(57) ABSTRACT

An electronic display device and corresponding method for providing a user with roster data. The roster data preferably pertains to participants in a plurality of groups, such as sporting teams. The device includes a memory, an input unit having a plurality of keys, a multi-line display, and a processing unit. The team name is selected preferably by initially selecting a home team and visitor team. The processing unit is operative to receive an identifier, e.g., a participant's jersey number, and preferably also the designation of a corresponding team via the input unit, and for retrieving the selected participant's corresponding roster data in response thereto. A multi-line display is adapted for simultaneously displaying the selected participant's identifier and at least a substantial portion of the participant's corresponding roster data. Alternatively, access to the team's schedule information is provided.

### CROSS REFERENCE TO RELATED APPLICATION

This application claims the benefit of U.S. Provisional Application No. 60/616,990, filed Oct. 7, 2004, which is incorporated by reference herein.

### FIELD OF THE INVENTION

This invention relates to information devices, and more specifically, to an electronic handheld device for enabling access to data associated with an identifier.

### BACKGROUND OF THE INVENTION

In the prior art, preprinted programs are often used to get further information about items identified in a roster. A roster can be any list of items, i.e., items that may or may not be sports related. Additional information is typically associated with the items on the roster. The additional information is also referred to herein as “roster data”. An identifier is typically associated with each of the listed items. In the sports context, for example, preprinted programs are often used by sports fans to get roster data regarding the player participants. A numerical identifier is typically used to identify the participants in the sports context. The numerical identifier is typically a jersey number worn by a player, a car number of a driver in a racing event, or some other numerical identifier for identifying the participant in an event. The roster data in the sports context typically includes several personal characteristics for an identified sports participant, e.g., the participant's name, position, height, weight, class or years of experience, hometown, and age. A drawback of known preprinted programs is that the roster data is typically presented in a tabular format, in smaller text fonts, and spread over separate pages in order to accommodate a large number of participants. A sports fan interested in information about a participant during the event must search through multiple pages and read relatively high density tabular information in the preprinted program, while, at the same time, trying not to miss the action in the event. Consequently, sports fans using preprinted programs are given the unfortunate choice of missing portions of the sporting event in order to locate and read the desired roster data in the program, or watching the event in ignorance of the roster data.

A known handheld device for accessing player names and other biographical information is disclosed in U.S. Pat. No. 5,653,634. With this device, a user is allowed to only view the player's name and jersey number in response to entry of the jersey number and designation of the player as a member of the home or visiting team. A drawback of the known device is that the device requires the user to use separate entry keys to obtain display of other biographical information that a typical fan desires, i.e., position (via a position key), age (via a date of birth key), and experience (via a “years” key), etc. The known device has the additional drawback of enabling a user to view only one piece of biographical information at a time on a single line display. For this known device, a user is required to turn his/her attention away from the sporting event in order to select one of the biographical information keys, view one line of corresponding biographical information, select another of the biographical information keys in turn, view one line of corresponding biographical information, and so on, in order to view multiple pieces of biographical information. The known device has five of these biographical keys, further decreasing the usefulness the device by a user desiring access to all stored biographical information for a participant without unnecessary interruptions to his/her viewing of the sporting event.

What is needed therefore is a user-friendly, menu-driven, lower cost portable device and corresponding method for providing roster data to a sports fan viewing a sporting event without unnecessary interruptions. What is also needed is a device that is operable in a non-sports context to provide a user with access to roster data associated with an identifier. What is also needed is a device that is operable to provide a user with access to roster data associated with an identifier associated with a group.

### SUMMARY OF THE INVENTION

The present invention provides an electronic display device and corresponding method for providing a user with roster data.

Broadly stated, the present invention provides an electronic handheld device for providing a user with roster data, comprising a memory for storing a plurality of identifiers and for storing corresponding roster data for each identifier, an input unit for enabling selection by the user of one of the identifiers; a processing unit operative for receiving the selected identifier from the input unit and for retrieving the corresponding roster data in response thereto; and a multi-line display adapted for simultaneously displaying the selected identifier and at least a substantial portion of the corresponding roster data.

Broadly stated, the present invention provides in another embodiment an electronic handheld device for providing a user with roster data, comprising a memory for storing a plurality of group names, for storing a plurality of identifiers associated with each of the group names, for storing a link for linking between each of the group names and the associated identifiers, and for storing corresponding roster data for each of the identifiers associated with each of the group names, an input unit for enabling selection by the user of one of the identifiers and for enabling selection by the user of one of the group names; a processing unit operative for receiving both the selected identifier and the selected group name from the input unit and for retrieving the corresponding roster data in response thereto, and a multi-line display adapted for simultaneously displaying the selected identifier, the selected group name, and at least a substantial portion of the corresponding roster data.

Broadly stated, according to yet another embodiment of the present invention, the input unit includes a mode selector for enabling the selection of a plurality of distinct device modes of operation, including a setup mode for enabling the user to select at least one of the group names from the plurality of group names and a data accessing mode wherein the roster data access is enabled; wherein the device also includes memory logic for selectively disabling access to a predefined portion of the roster data stored in the memory and an unlock mode for enabling input of the predetermined unlock code to enable access to the predefined portion of the roster data, and wherein the mode selector includes an unlock mode for enabling input of a predetermined unlock code to enable access to said predefined portion of said roster data stored in said memory.

Broadly stated, the present invention also provides a method for providing a user with roster data via a handheld device, comprising the steps of storing a plurality of identifiers and corresponding roster data for each identifier in the handheld device, receiving selection by the user of one of the identifiers via the handheld device; retrieving the corresponding roster data in response to the identifier selection; and simultaneously displaying the selected identifier and at least a substantial portion of the corresponding roster data.

An advantage of the present invention is that it provides a handheld device and corresponding method for providing roster data to a user on a multi-line display with a menu driven user interface that enables users to access roster data much more efficiently. A related advantage of the present invention is that it provides more roster data to a user in a more easily accessible manner such that a user can more easily access the desired roster data and view a sporting event with reduced interruptions. Another advantage of the present invention is that it provides a device and corresponding method that is operable in a non-sports context to provide a user with access to roster data associated with any identifier.

These and other embodiments, features, aspects, and advantages of the invention will become better understood with regard to the following description, appended claims, and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a view of a handheld electronic device according to a preferred embodiment of the present invention;

FIG. 2 illustrates the device in FIG. 1 showing a display in a “team select” mode;

FIG. 3 shows the device in FIG. 1 displaying a screen prompting the user to confirm the team selection;

FIG. 4 shows the device in FIG. 1 displaying a main menu in response to selection of the menu key;

FIG. 5 shows the device of FIG. 1 displaying an introductory screen for the “game” mode;

FIG. 6 shows the device of FIG. 1 displaying an information screen that displays to the user the roster information of a selected participant;

FIG. 7 shows an exemplary map of a portion of the memory storing the roster information associated with a particular numerical identifier;

FIG. 8 show an alternate main menu displayed in response to selection of the menu key according to a second embodiment of the present invention;

FIG. 9 shows a device displaying an exemplary team schedule select screen in response to selection of the schedule mode from the alternate main menu of FIG. 8;

FIG. 10 shows a device displaying a portion of the schedule for the “California” team in response to selection thereof;

FIG. 11 is a third embodiment of the device and method according to the present invention;

FIG. 12 illustrates the device of FIG. 1 displaying a main menu screen on the multi-line display;

FIG. 13 shows the device of FIG. 11 with an exemplary screen prompting the user to enter the unlock code;

FIG. 14 illustrates the device of FIG. 11 displaying an “enter code” screen in response to selection of the corresponding menu item displayed in FIG. 12 and after entry of an unlock code;

FIG. 15 is a block diagram illustrating an Internet-connected computer querying an Internet-based database with a device unique serial number during the process of obtaining the unlock code for the device;

FIG. 16 is a block diagram illustrating schematically a top level memory map for an exemplary memory of the device of FIG. 11;

FIG. 17 is a flow chart illustrating a process for determining whether to unblock memory based on a code entered by a user;

FIG. 18 is a block diagram showing a conventional memory and a conventional processing unit in the device of FIG. 1 connected in a well known way via a conventional bus; and

FIG. 19 is a block diagram showing the diagram in FIG. 18 further including the memory logic of the device in FIG. 11.

Reference symbols are used in the Figures to indicate certain components, aspects or features shown therein, with reference symbols common to more than one Figure indicating like components, aspects or features shown therein.

### DETAILED DESCRIPTION OF THE INVENTION

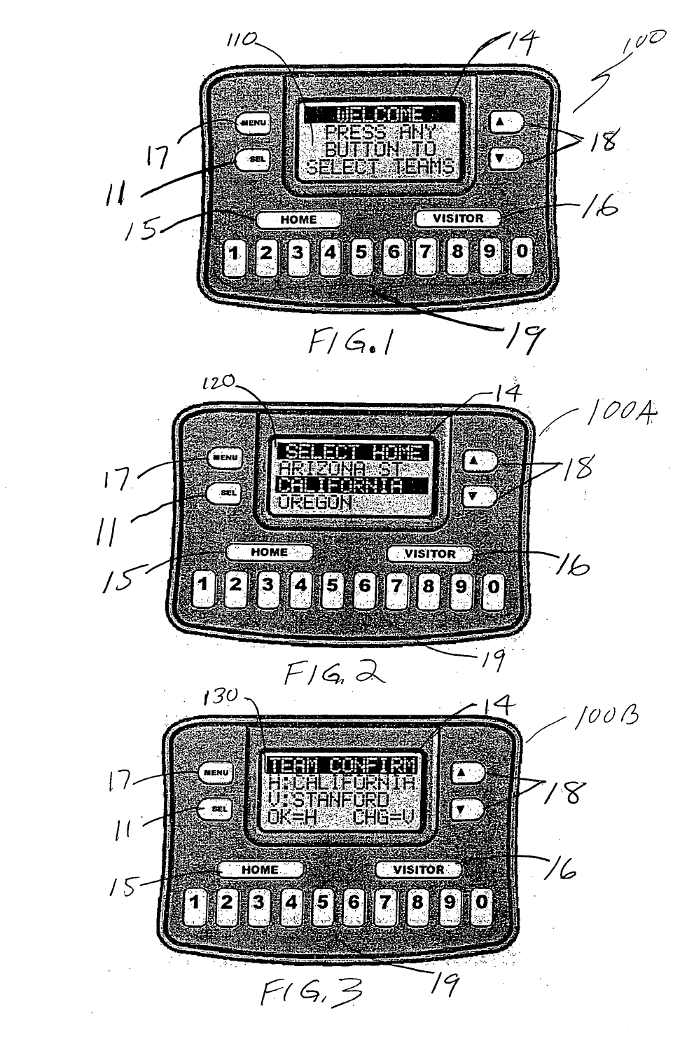

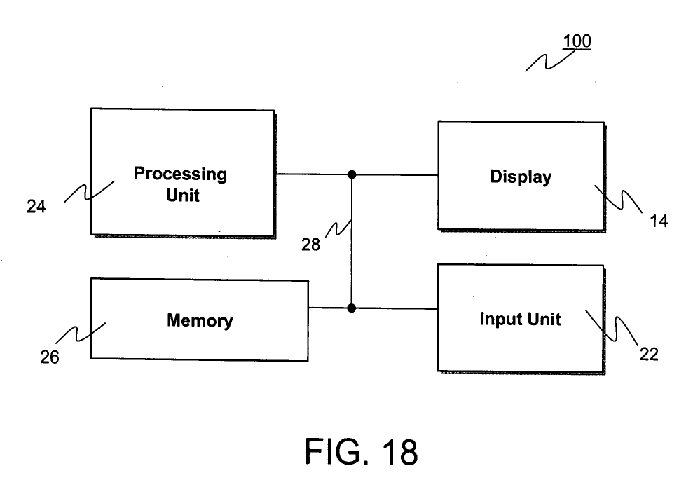

The electronic handheld device according to the present invention is for providing a user with roster data, e.g., roster information. FIG. 1 is a view of a handheld electronic device 100 according to a preferred embodiment of the present invention. The device 100 includes a multi-line display 14, and an input unit comprising a plurality of keys. The input unit for device 100 includes a “menu” key 17, a select key 11 labeled “sel”, scrolling keys 18, numeric entry keys 19, a “home” key 15, and a “visitor” key 16. A memory and a processing unit are also included in device 100. The memory and the processing unit are conventional elements well known to one of ordinary skill in the art; see e.g., FIG. 18. FIG. 18 shows a conventional memory 26 and a conventional processing unit 24 connected in the device 100 in a well known way via a conventional bus 28. Power for device 100 preferably is from an internal battery (not shown). Other suitable means for powering a handheld device as known in the art may also be used within the scope of the present invention, e.g., solar power.

The memory 26 provides storage for storing a plurality of identifiers and for storing corresponding roster data. According to a preferred embodiment the memory 26 provides storage for a plurality of group names, a plurality of identifiers associated with each of the group names, a link for linking between each of the group names and the associated identifiers, and corresponding roster data for each of the identifiers associated with each of the group names. Each group is preferably a sports team having a team name, e.g. the University of California Golden Bears football team, and each identifier is a numerical identifier that identifies a member of each team. Although teams, team names, players, and numerical identifiers are used in some examples in the figures and description, the present invention can be used for any items represented by identifiers and corresponding groups. The present invention is not limited to numerical identifiers. Non-numerical identifiers may be used in accordance with the present invention e.g., different colors to identify a jockey and horse. According to an alternate embodiment, the device enables access to roster data based on a selected identifier without requiring selection of a group name, i.e., no group names may be applicable. For example, a device within the scope of the present invention is usable by a NASCAR fan for obtaining roster data based on selection of a numerical identifier for a driver/car without requiring selection of a group name.

The input unit 22 of device 100 enables a user to input a numerical identifier and a team name. The processing unit 24 is operative to receive one of the numerical identifiers and a team name from the input unit 22 and for retrieving the corresponding roster data in response thereto. Multi-line display 14 is adapted for simultaneously displaying a selected numerical identifier and at least a substantial portion of the corresponding roster data. The operation of device 100 is described in further detail below.

In operation, teams of interest preferably are selected from a list of teams stored in device 100 memory prior to the normal operation of the device 100. A welcome screen 110 as seen on the exemplary multi-line display 14 in FIG. 1 is preferably displayed on the device 100 after initial power on. The welcome screen 110 prompts the user to enter the setup mode where the user can begin the process of selecting teams of interest, i.e., by pressing any button as shown in the exemplary welcome screen in FIG. 1. An introductory “splash” screen containing text and graphics is preferably displayed on the device 100 prior to display of the welcome screen. The splash screen may contain an advertisement message retrieved from memory 26, such as a logo. According to a preferred embodiment, the user is prompted at the bottom of the splash screen to enter any key in order to proceed to the menu.

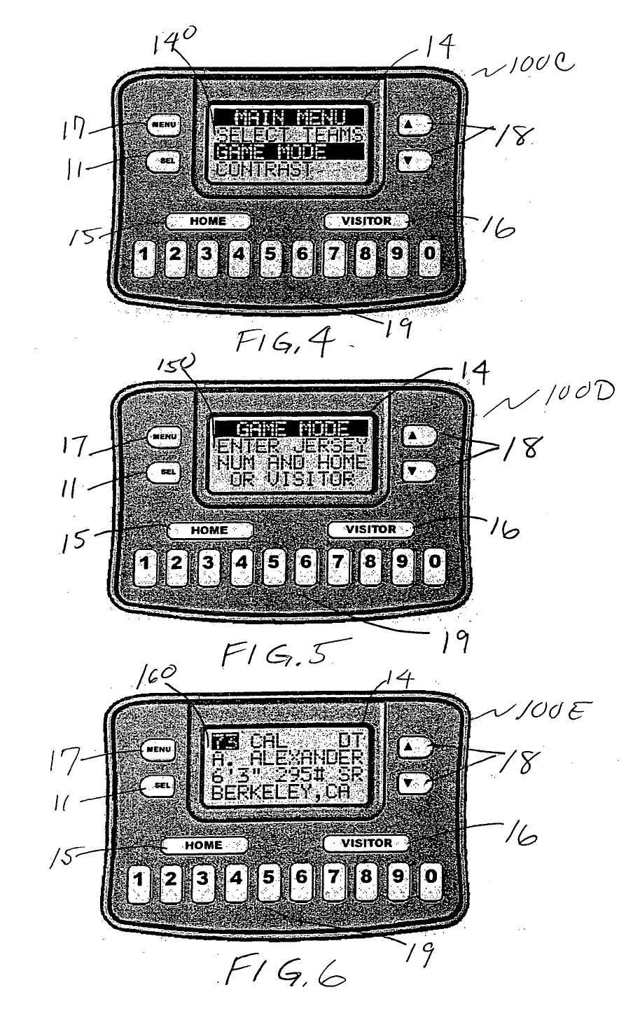

The input unit 22 includes a mode selector for enabling the selection of a plurality of distinct modes of operation. FIG. 2 illustrates the device 100 in FIG. 1 in a setup or “team select” mode. The device is identified as 100A in the mode shown in FIG. 2. The “team select” mode provides an interface to enable the user to preferably specify the names of a home team and a visitor team from a plurality of team names stored in memory 26. Multi-line display 14 in FIG. 2 shows a screen 120 prompting the user to select the home team. The processing unit 24 is operative for retrieving the team names from memory 26 for display in the “team select” mode. In operation, the user selects the home team by pressing the scroll buttons 18 as required until the desired team name is highlighted on multi-line display 14 and then pressing the “sel” button to make the selection. A screen is displayed after the home team has been selected to enable selection of the visitor team from a list of teams.

FIG. 3 shows the device in FIG. 1 displaying an exemplary screen prompting the user to confirm the home and visitor team selections, i.e., a “team confirm” mode. The device is identified as 100B in the mode shown in FIG. 3. In the example shown in FIG. 3, the user is prompted to confirm the selection of California as the home “H” team, and Stanford as the visitor “V” team, by pressing the home “H” key, i.e. “OK=H”. The user is prompted to press the visitor “V” key if the user desires to change the selection, i.e., CHG=V”. The above selection process is repeated if the user indicates a change is desired. According to an alternate embodiment, the user is not prompted to confirm the team selections.

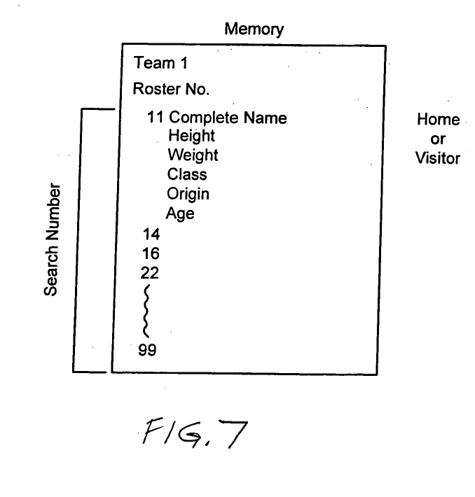

Once the initial selection of home and visitor teams has been confirmed, the device 100 enables the user to selectively enter a data accessing mode for enabling the user to input a numerical identifier and designation of home or visitor team, also referred to herein as the “game” mode, in order to access roster data for a selected team participant and have this data be displayed on multi-line display 14. In other words, device 100 and what is displayed on multi-line display 14 are menu-driven. The device 100 displays a main menu 140 as seen in FIG. 4 in response to selection of the menu key 17. The device is identified as 100C in the mode shown in FIG. 4. The “game” mode selection on the main menu is shown highlighted in FIG. 4.

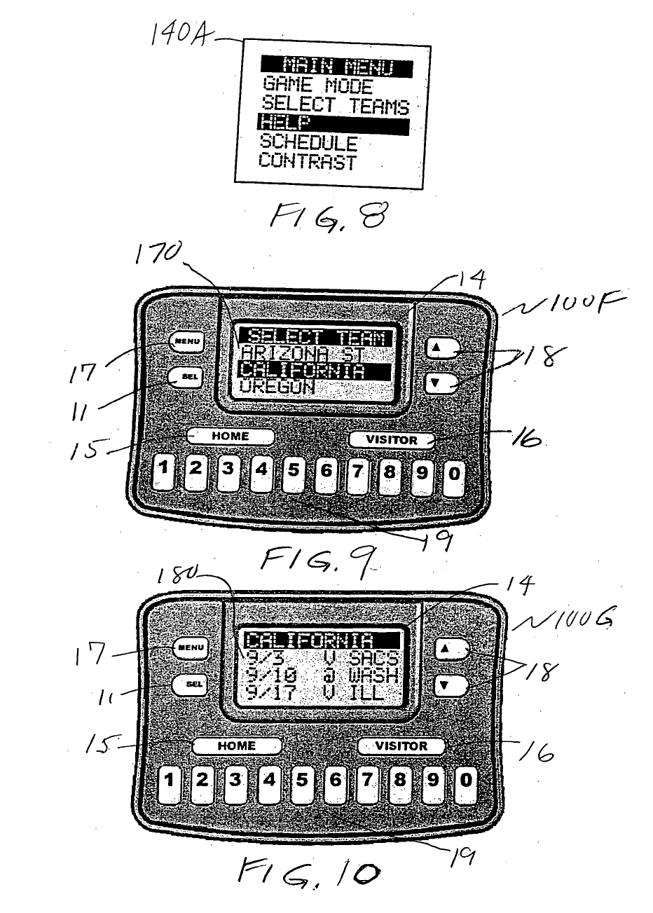

FIG. 5 shows the device of FIG. 1 displaying an introductory screen 150 for the “game” mode. The device is identified as 100D in the “game” mode shown in FIG. 5. As seen in FIG. 5, the user is prompted on the introductory screen 150 on display 14 to enter a jersey number (“num”), i.e., a numerical identifier, and a home or visitor team. The processing unit 24 in device 100 is operative to receive one of the numerical identifiers entered by the user via the numeric entry keys 19. The user selects either the home or visitor team via the corresponding home key 15 or visitor key 16, preferably after entry of the numerical identifier. The processing unit 24 receives the selection of home team or visitor team. The corresponding team name is determined by the user selection of home or visitor and the prior user selections thereof in the “team select” mode.

In response to input of the numerical identifier and indication of the corresponding desired team, the processing unit 24 in device 100 retrieves the corresponding roster data from the memory 26 of the device 100. The processing unit 24 contains logic for processing the roster data for display on the multi-line display 14. The multi-line display 14 is adapted for simultaneously displaying one of the numerical identifiers and at least a substantial portion of the corresponding roster data. Preferably the multi-line display 14 is adapted for simultaneously displaying a numerical identifier and the entire portion of the corresponding roster data.

FIG. 6 shows the device of FIG. 1 displaying an information screen 160 that displays to the user the roster data of a selected participant. The device is identified as 100E in the mode shown in FIG. 6. The roster data preferably comprises, in addition to the team name and numerical identifier, at least two categories selected from a group consisting of: participant name, participant position, participant height, participant weight, participant hometown of origin, and participant age. The roster data preferably also comprises a participant's class year for a member of a college sports team. The roster data may include years of experience or other related information for participants in other sporting contexts.

The information screen 160 on display 14 for the example shown in FIG. 6 show roster data presented in response to entry of the number “76” and selection of “home” team. For this example, the home team is “California”, as seen in the team confirmation screen shown in FIG. 3. In addition to display of the numerical identifier “76”, the corresponding selected (home) team, California shown as “CAL”, the information screen 160 displays the following roster data: participant name “A. Alexander”, position of defensive tackle shown as “DT”, height of six foot three inches shown as “6′ 3″”, weigh of 295 pounds shown as “295#”, class year equals senior shown as “SR”, and a hometown of origin of Berkeley, California, shown as “BERKELEY, CA”. It should be appreciated that the arrangement of the roster data shown in display 14 in FIG. 6 is exemplary only—the data can be arranged, according to the present invention, in a different order or presented with different acronyms or identifying information. For example, the height can be shown alternatively as “6-3”, “HT: 6′ 3″”, or “HT: 6-338 . One factor affecting the display is the number of characters the display 14 can accommodate. An exemplary screen showing this roster data in a different format is display 210 in FIG. 11.

In the example shown in FIG. 6, the multi-line display 14 preferably displays four lines in the mode shown for this embodiment and includes the entire portion of the roster data for participant 73 on the California team. Alternatively, the multi-line display 14 is adapted for displaying at least a substantial portion of the roster data with scroll keys 18 enabling access to any additional roster data not initially displayed for the selected identifier. Preferably the multi-line display can display at least three lines of text. Preferably, the device 100 enables a user to scroll up (or down) in data accessing mode to access roster data associated with the next (or previous) identifier in sequence.

Preferably, a sleep mode is provided for the device in order to conserve power. The sleep mode is activated when the keys of the input unit 22 have been inactive for a predetermined period of time. Ways for implementing a sleep mode in a handheld device are well known to one of ordinary skill in the art. The display is shut down to conserve power in the sleep mode. The information screen 160 shown in FIG. 6 is displayed until the device enters the sleep mode, another numerical identifier is entered, the menu button is selected, or power is turned off using a power on/off button (not shown).

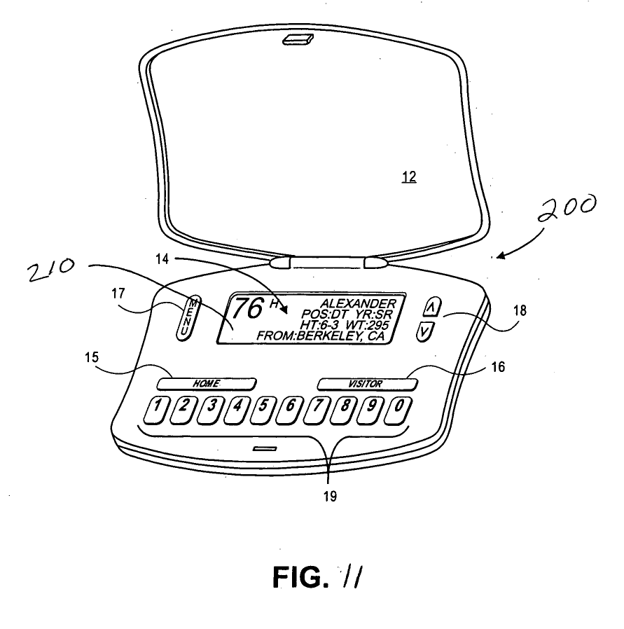

FIG. 7 shows an exemplary map of a portion of the memory 26 storing the roster data associated with the numerical identifier “11”. The roster data shown in the example in FIG. 7 includes name, height, weight, class (year), origin (hometown), and age. The numerical identifier “11” is associated with Team 1, which may be home or visitor, as seen in FIG. 7.

Any team selectable on the device 100 may be designated as the home team or visitor team. That is, the selection of teams need not be tied to a particular schedule, so the device 100 enables a user to access roster data for players on two teams competing in a non-regular season game, e.g., a bowl game or a playoff game. The selected home team preferably remains designated as the home team in the device 100, including after power-off, until a different home team is selected by the user. Preferably, the roster data for all teams in the National Collegiate Athletic Association (NCAA) Division 1A is stored and selectable on the device 100. It should be appreciated that the device may also be configured to store any number of teams in any sport, league, or level, limited only by the amount of memory in the device.

The device and method according to a second embodiment of the present invention also stores schedule information in memory and provides access thereto to a user. The schedule information preferably comprises one or more schedules corresponding to the team names stored in memory. FIG. 8 show an alternate main menu 140A that is displayed in response to selection of the menu key according to a second embodiment of the present invention. In the example shown in FIG. 8, five separate modes of operation of device 100 are shown. FIG. 9 shows a device displaying an exemplary team schedule select screen 170 in response to selection of the “schedule mode” from the alternate main menu of FIG. 8. The device according to the second embodiment is identified as 100F in the exemplary “schedule mode” shown in FIG. 9.

The team schedule select screen 170 on multi-line display 14 in FIG. 9 provides an interface to prompt the user to specify the name of a team stored in memory for which schedule information is desired. The processing unit is operative for retrieving the schedule for the team highlighted on screen 170 in response to the user selection of the “Sel” key 11. In the example shown in FIG. 9, “California” is highlighted. FIG. 10 is displayed in response to the selection via the “sel” key 11 when “California” is highlighted in FIG. 9. FIG. 10 shows a screen 180 on the device displaying a portion of the schedule for the “California” team in response to selection thereof. The device according to the second embodiment is identified as 100G in the mode shown in FIG. 10. In operation, the device and corresponding method enables the user to view the other portions of the schedule stored for the selected team through use of the scroll buttons 18.

FIG. 11 is a third embodiment of the device and method according to the present invention. As can be seen, the device 200 in FIG. 11 is similar to the device 100 of FIG. 1, but does not include the 37 sel” key 11 and adds a cover 12. The cover 12 provides a “clamshell” appearance to the device 200 so as to protect the input unit keys and display while providing an area for placement of advertising messages, team logos, etc. FIGS. 12-14 show device 200, albeit without the cover 12, in various modes as described in further detail below.

FIG. 12 illustrates the device 200 displaying a main menu screen 220 on the multi-line display. The device is identified as 200A in the mode shown in FIG. 12. The main menu screen 220 is displayed in response to a user selection of the menu key 17 on device 200. The main menu screen 220 includes a “game” mode, “select teams” mode, and an “enter code” mode. The “game” and “select teams” modes of device 200 operate similarly as described above for device 100 with differences as described in further detail below. For instance, the roster data screen for device 200 is different than for device 100 as shown in comparing screen 160 in FIG. 6 and screen 210 in FIG. 11. As described above, the “select teams” mode enables the user to select the names of a home team and a visiting team from memory. The device 200 enables selection of the teams without use of a select key 11. For example, the device enables the user to select a home team by selecting the home team key 15, and scrolling the display as necessary to highlight the name for the desired home team, and then selecting the home team key 15 again.

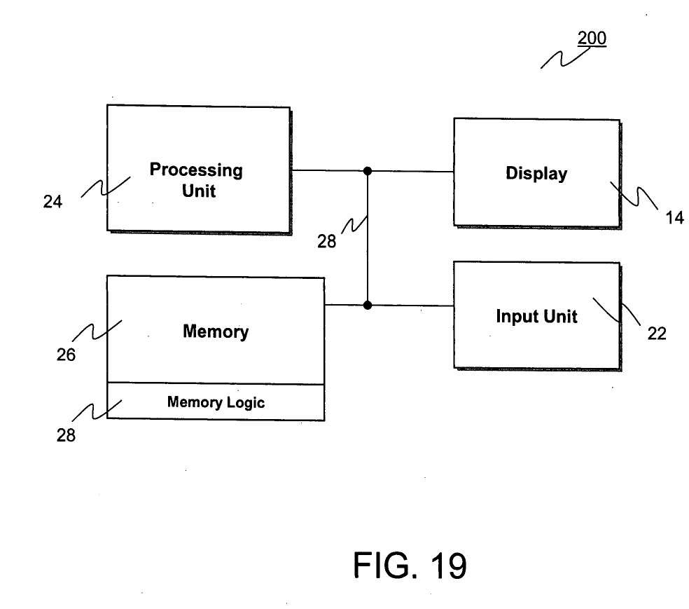

The device 200 according to the third embodiment includes memory logic 28 for selectively disabling and enabling access to at least a portion of the roster data stored in memory, see e.g., FIG. 19. FIG. 19 is a block diagram showing the diagram in FIG. 18 further including memory logic of device 200. A unique unlock code is assigned to each device and stored in memory thereof. The device 200 enables entry of the unlock code via numeric entry keys 19. The device 200 is preferably distributed to home team sports fans and enables roster data of the home team and the first opponent on the home team's schedule only. In other words, use of the device 200 at a first home game between the home team and the first opponent is complimentary, with the roster data for the rest of the teams being blocked for the first game. The device 200 enables a user to decide after the end of the first home game whether he or she would like to continue to use the same device thereafter, e.g., for the remaining games in the season.

FIG. 16 is a block diagram illustrating schematically a top level memory map for an exemplary memory 20 of device 200. An exemplary memory contains the names and corresponding roster data for 200 teams, i.e., Team 1 “California” to Team 200 “USC” as seen in FIG. 16. Although 200 teams are shown in FIG. 16, the maximum number of teams stored on the device according to the present invention is limited only by the size of the memory and the number of available teams. It should also be appreciated that the team names for the present invention preferably contains more description than shown in FIG. 16 in order to differentiate teams having the same acronym, i.e., “USC” could be the University of Southern California or the University of South Carolina.

The memory map 20 is shown with opposing teams 1 and 2, i.e., California and Stanford respectively, having their roster data accessible in memory area 21 and respective team 3 through team 200 blocked from immediate access in memory area 22. Team 1 (California) has been initially preselected as the home team with team 2 (Stanford) preselected as the visitor. The device 200, as initially distributed, preferably enables access to roster data only for the first two selected teams, e.g., California and Stanford. Further use of the device to access other roster data is limited in device 200 to only team 1 at the end of the game between team 1 and team 2 unless further steps are successfully performed by the user.

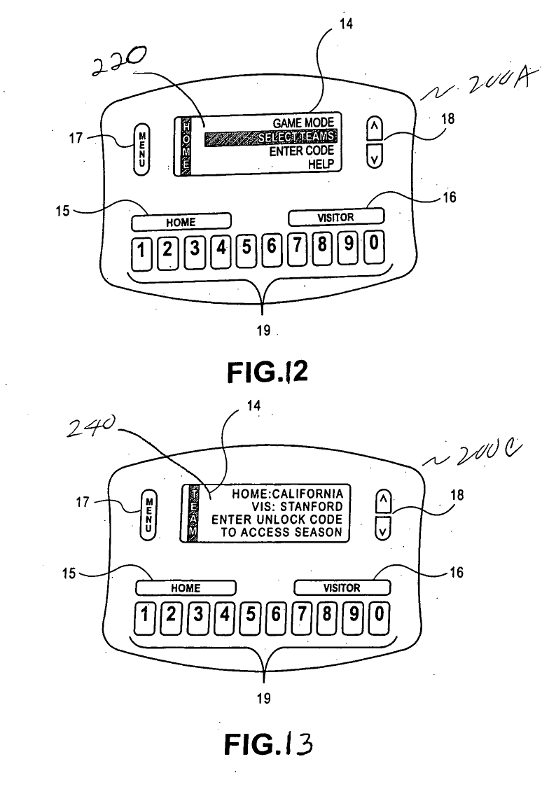

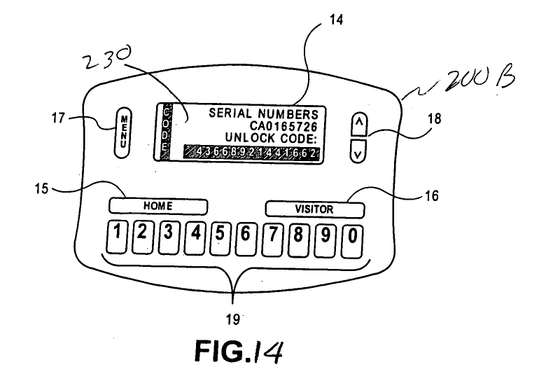

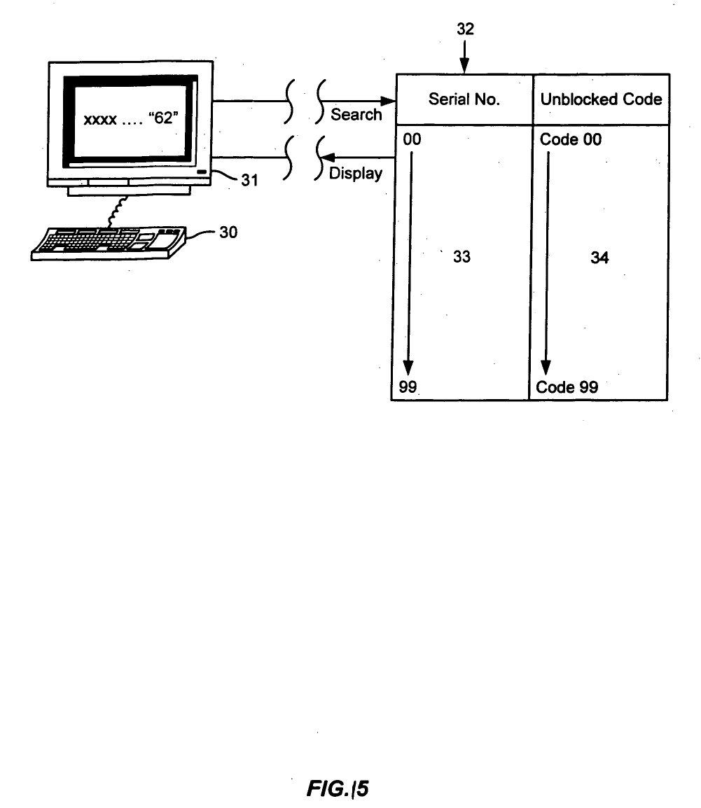

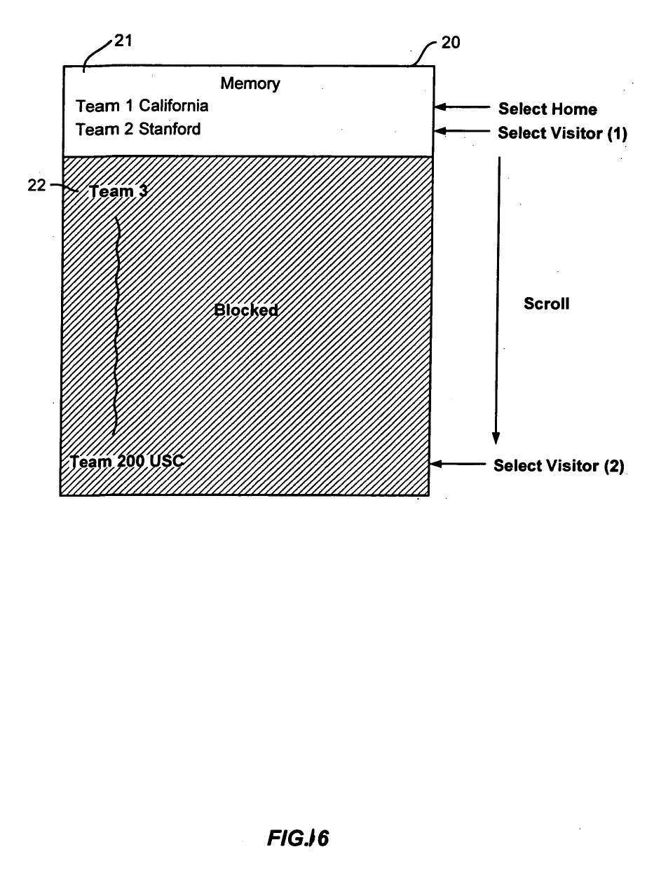

The device 200 enables the user to enter an unlock code in order to enable access to roster data for those remaining games. FIG. 13 shows the device 200 with an exemplary screen prompting the user to enter the unlock code. The device is identified as 200C in the mode shown in FIG. 13. The device enables the user to enter the unlock code via the “enter code” mode selection shown on screen 220 in FIG. 12. The entire roster data stored in the memory of device 200 is activated in response to entry of the device's unlock code and is preferably accessible for the remainder of the season.

A user desiring access to the blocked (disabled) roster data, i.e., the blocked portion of memory 22 shown in FIG. 16, must first select the “enter code” selection shown in FIG. 12. FIG. 14 illustrates the device of FIG. 11 displaying an “enter code” screen 230 in response to selection of the corresponding “enter code” menu item displayed in FIG. 12 and after entry of an unlock code. The unlock code shown highlighted in this example on screen 230 was entered by a user. The serial number of device 200, i.e., “CA0165726” in this example, is displayed on screen 230. According to an alternate embodiment, the unlock code is a function of the last two characters of the device unique serial number, i.e., “26” in this example. Alternatively, the unlock code can be made a function of any number of digits of the device unique serial number or completely independent of the serial number. The unlock code is also referred to herein as the unblock code.

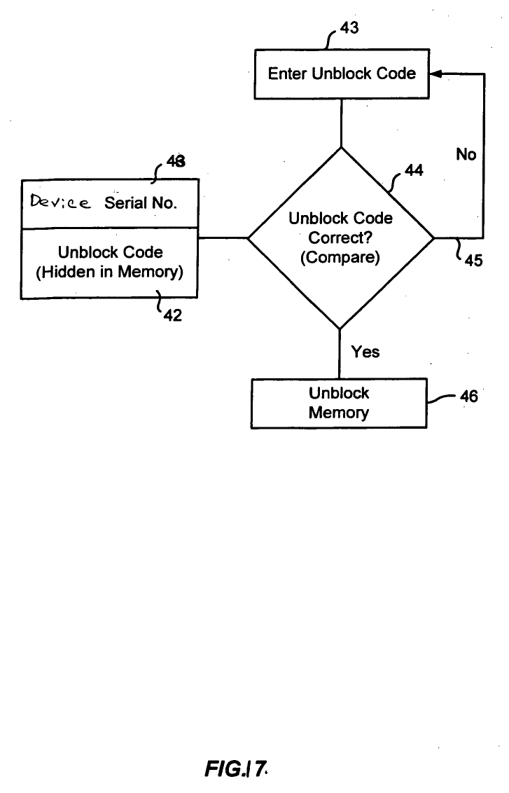

The present invention enables a user to obtain the unlock code for the device via a network such as the Internet in exchange for a payment of some kind. FIG. 15 is a block diagram illustrating an Internet-connected computer querying an Internet-based database with a device unique serial number during the process of obtaining the unlock code for the device. As seen in FIG. 15, an Internet-connected computer having a keyboard 30 and a display 31 queries an Internet-based database 32 with a device unique serial number in order to obtain the unblock code for that device; i.e., after payment has been made. The interconnected database 32 contains a mapping of device serial numbers 33 and the corresponding unlock codes 34. The matching unlock code, e.g. “62” shown in FIG. 15 corresponding to serial number ending in “26” , is sent to the computer for display on display 31 if the user has paid the required fee or other requirements to obtain the user code.

FIG. 17 is a flow chart illustrating a process for determining whether to unblock memory based on a code entered by a user. In Step 43, the user attempts to enter the unblock code, i.e., the unlock code. In Step 44, a determination is made as to whether the code entered by the user is the correct unblock code associated with the serial number for the user's device; e.g., for the serial number shown in FIG. 14. The process proceeds back to Step 43 if the code entered by the user is not the correct unblock code for the device, as shown at 45, and the user is again prompted to enter the correct unblock code. In Step 46, the device unblocks memory if the correct unblock code was entered in Step 43. The unique unblock code corresponding to the device is maintained in its memory to enable comparison of a code entered by a user at Step 42 in FIG. 17. The unblock code 42 and corresponding serial number 47 stored in memory for device 200 are also shown in FIG. 17. The unblocking of memory in Step 46 in FIG. 17 causes the device 200 to enable access to the user to the previously unblocked memory area of the device which stores the roster data for the additional teams, e.g., shown as 22 in FIG. 16.

For example, presume user A is attending a second game in which Team 1 (California) is facing team 200 (USC) after memory 22 is unblocked at shown as Step 46 in FIG. 17 in response to successfully entry of the unblock code. To access the roster data for visiting team 200, user A selects the visiting team 200 by using the “Select Teams” menu selection shown in FIG. 12, followed by depressing the “Visitor” key 16. According to an embodiment of the device of the present invention, all roster data stored in memory of the device 200, e.g., for 200 teams shown in FIG. 16, is accessible by the user once the memory 22 is unblocked as described above.

It will be understood that others variation in the device according to the present invention may be provided. According to another alternate embodiment, the device provides for receipt and storage of mid-season or inter-season database updates transmitted to the device, e.g., via electronic, infrared, radio frequency, and other modes of transmission. Alternatively, database updates can be received and stored at other times.

The present invention is applicable to any number of events where discrete information groupings can be accessed by reference to numbers, i.e., not just sporting events. For example, the device within the scope of the present invention is configurable to allow a visitor to a museum to enter an identifier for a work of art of interest and retrieve further information about the selected artwork that is stored on the device. In another alternate embodiment, the device can transmit the roster data to a user via audio in addition to or in lieu of the visual display, e.g., to enable use by the blind and other vision impaired individuals. Although the memory capacity is described as comprising roster data for approximately 200 teams, one skilled in the art would recognize that the device memory can readily expanded to accommodate the requirements for any given application.

The invention has been described with regard to specific embodiments. Variations on these embodiments and other embodiments may be apparent to those of skill in the art. It is therefore intended that the invention not be limited by the discussion of specific embodiments. It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An electronic handheld device for providing a user with roster data, comprising:
a memory for storing a plurality of identifiers and for storing corresponding roster data for each identifier,
an input unit for enabling selection by said user of one of said identifiers;
a processing unit operative for receiving said selected identifier from said input unit and for retrieving said corresponding roster data in response thereto; and
a multi-line display adapted for simultaneously displaying said selected identifier and at least a substantial portion of said corresponding roster data.

2. An electronic handheld device for providing a user with roster data, comprising:
a memory for storing a plurality of group names, for storing a plurality of identifiers associated with each of said group names, for storing a link for linking between said each of said group names and said associated identifiers, and for storing corresponding roster data for each of said identifiers associated with each of said group names,
an input unit for enabling selection by said user of one of said identifiers and for enabling selection by said user of one of said group names;
a processing unit operative for receiving both said selected identifier and said selected group name from said input unit and for retrieving said corresponding roster data in response thereto, and
a multi-line display adapted for simultaneously displaying said selected identifier, said selected group name, and at least a substantial portion of said corresponding roster data.

3. The device of claim 2, wherein said identifier is a numerical identifier.

4. The device of claim 2, wherein said input unit includes a mode selector for enabling the selection of a plurality of distinct device modes of operation, including a setup mode for enabling said user to select at least one of said group names from said plurality of group names and a data accessing mode wherein said roster data access is enabled.

5. The device of claim 4, wherein said setup mode enables selection of two group names and said data accessing mode enables selection of one of said identifiers and one of said selected group names.

6. The device of claim 4, further comprising memory logic for selectively disabling access to a predefined portion of said roster data stored in said memory.

7. The device of claim 6, wherein said mode selector includes an unlock mode for enabling input of a predetermined unlock code to enable access to said predefined portion of said roster data stored in said memory.

8. The device of claim 2, wherein said input unit includes scroll keys operable for scrolling said corresponding roster data for viewing additional roster data on said multi-line display.

9. The device of claim 4, wherein said input unit includes scroll keys operable in said setup mode for scrolling said plurality of group names for viewing said group names and for enabling selection of one of said group names and operable in said data accessing mode for scrolling said corresponding roster data for viewing additional roster data on said multi-line display.

10. The device of claim 4, wherein each said group is a sports team and each said identifier is a numerical identifier of a member of a sports team, said input unit includes one or more keys for designating one said sports team name as a home team and designating one said sports team name as a visitor team and includes a plurality of numeric keys for selecting a numerical identifier.

11. The device of claim 10, wherein said setup mode enables selection of one said sports team name as a home team and enables selection of another said sports team name as a visitor team, and said data accessing mode enables selection of one said numerical identifiers from the selected said home team or said visitor team.

12. The device of claim 10, wherein each said numerical identifier is a sports team member's jersey number.

13. The device in claim 2, wherein each said identifier identifies a participant in a sporting event and said roster data comprises at least two categories selected from a group consisting of: participant's name, participant's height, participant's weight, participant's hometown, participant's age, participant's postion, and the participant's years of experience.

14. The device in claim 2, wherein one or more event schedules associated with each of said plurality of group names is stored in said memory, and wherein access to each said schedule is enabled by said device.

15. A method for providing a user with roster data via a handheld device, comprising the steps of:
storing a plurality of identifiers and corresponding roster data for each identifier in said handheld device,
receiving selection by said user of one of said identifiers via said handheld device;
retrieving said corresponding roster data in response to said identifier selection; and
simultaneously displaying said selected identifier and at least a substantial portion of said corresponding roster data.

16. The method of claim 15, further comprising the steps of:
storing a plurality of group names; wherein said storing of said plurality of identifiers comprises storing said identifiers associated with each of said group names;
storing a link for linking between each of said group names and said associated identifiers, wherein said stored corresponding roster data is for each of said identifiers associated with each of said group names, and
receiving selection by said user of one said group name, and wherein said corresponding roster data is retrieved in response to selection of both said identifier and said group name.

17. The method of claim 16, wherein said handheld device includes a mode selector for enabling the selection of a plurality of distinct device modes of operation, including a setup mode for enabling said user to select at least one of said group names from said plurality of group names and a data accessing mode wherein said roster data access is enabled.

18. The method of claim 17, wherein said setup mode enables selection of two group names and said data accessing mode enables selection of one of said identifiers and one of said selected group names.

19. The method of claim 15, further comprising the steps of selectively disabling access to a predefined portion of said roster data and storing a predetermined unlock code in said device.

20. The method of claim 19, wherein said device includes a mode selector including an unlock mode for enabling input of said predetermined unlock code, wherein access to said predefined portion of said roster data is enabled in response thereto.
